(19) United States
(12) Patent Application Publication
(10) Pub. No.: US 2008/0281971 A1
(43) Pub. Date: Nov. 13, 2008

(54) NETWORK MULTIMEDIA COMMUNICATION USING MULTIPLE DEVICES

(75) Inventors: Eva-Maria Leppanen, Lempaala (FI); Arto Leppisaari, Kangasala (FI)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation, Espoo (FI)

(21) Appl. No.: 11/745,439

(22) Filed: May 7, 2007

(51) Int. Cl. G06F 15/16

(52) U.S. Cl. 709/228

(57) ABSTRACT

Various embodiments are described relating to multimedia communication using multiple devices in a network. In an example embodiment, a request for a communication session may be received at a first server. Parameters associated with the communication session may be negotiated. One or more of the devices included in a group of one or more devices associated with a first user may be selected for receipt of one or more portions of a requested transmission based on the negotiated parameters.

### BACKGROUND

As networking technology has advanced, a variety of networks have been installed, including networks that support wired and/or wireless communications. For example, the Open Mobile Alliance (OMA) includes groups working to facilitate global user adoption of mobile data services by specifying market driven mobile service enablers for ensuring service interoperability across devices, geographies, service providers, operators, and networks. As another example, an Internet Engineering Task Force (IETF) Session Initiation Protocol (SIP) is a protocol for the development of session-based applications, as discussed, for example, in IETF RFC3261. A number of working groups are working to improve on this technology.

Example Internet applications may involve the creation and management of sessions, wherein a session may be considered as an exchange of data between an association of participants. Several protocols have been proposed that may carry various forms of real-time multimedia session data such as voice, video, or text messages. The Session Initiation Protocol (SIP) may work in concert with these protocols by enabling Internet endpoints, which may be referred to as user agents, to discover one another and to agree on a characterization of a session they would like to share. For locating prospective session participants, and for other functions, SIP may provide means for the creation of an infrastructure of network hosts, which may be referred to as proxy servers, to which user agents may send registrations, invitations to sessions, and other requests.

Instant Messaging (IM) is a form of two-way communications in which users may exchange information with others interactively, for example, users may exchange messages in near real time to engage in conversations. Such exchanges may, for example, rely on a low latency in the delivery of messages. For example, text messages may be exchanged; however, example enablers have been proposed that may support content types beyond text.

Additionally, example Push to talk over Cellular (PoC) techniques may provide rapid communications for business and consumer customers of mobile networks. Using PoC, voice and data communications may be shared with a single recipient, (e.g., one-to-one) or between groups of recipients as in a group chat session, (e.g., one-to-many).

As another example, Third Generation Partnership Project (3GPP) Internet Protocol (IP) Multimedia Subsystems (IMS) techniques may provide an IP-based session control capability based on the SIP protocol. IMS may be used to enable services such as push to talk, instant messaging, presence and conferencing.

As an example scenario, a user may wish to participate in a one-to-one or group communication using several devices simultaneously. Therefore, efficient techniques for a user to communicate in a session using several devices simultaneously may be desirable.

### SUMMARY

Various embodiments are described relating to multimedia communication using multiple devices in a network.

According to an example embodiment, a request for a communication session may be received at a first server. Parameters associated with the communication session may be negotiated. One or more devices included in a group of one or more devices associated with a first user may be selected for receipt of one or more portions of the requested transmission based on the negotiated parameters.

According to another example embodiment, a request for a communication session including information indicating a requested transmission to a first user associated with a group of one or more devices may be received at a first server. One or more of the devices included in the group of devices may be selected for receipt of one or more portions of the requested transmission based on parameters associated with the group of devices. The communication session may be generated, wherein the communication session comprises a communication session between the first user and a network node, wherein the network node may receive, from the first server, identifying information associated with the first user indicating the first user as a single network entity including a combination of capabilities associated with the group of one or more devices.

According to another example embodiment, a request for a communication session with a first user may be sent from a network node. Parameters associated with the communication session may be negotiated, wherein the first user is associated with a group of one or more devices, and wherein a first server selects one or more of the devices included in the group of devices for receipt of one or more portions of a requested transmission.

According to another example embodiment, a first portion of a transmission may be received by a device associated with a first user, from a first server, based on negotiated parameters, wherein the first user is associated with a group of one or more devices including the device, wherein the transmission comprises a transmission to the first user that is requested by a network node, wherein the first server selects one or more of the devices included in the group of devices for receipt of one or more portions of the requested transmission based on the negotiated parameters, wherein the one or more portions includes the first portion. Receiving the first portion may include receiving, by the device associated with the first user, from the first server, the first portion of the transmission based on the negotiated parameters and the selecting.

According to another example embodiment, an apparatus for communications may include a controller, a memory coupled to the controller, and a network transceiver coupled to the controller. The apparatus may be adapted to receive a request for a communication session with a first user associated with a group of one or more devices, negotiate parameters associated with the communication session, and select one or more of the devices included in the group of devices for receipt of one or more portions of a requested transmission based on the negotiated parameters.

According to another example embodiment, a computer program product may be tangibly embodied on a computer-readable medium and may be configured to cause a data processing apparatus to receive a request for a communication session, negotiate parameters associated with the communication session, receive information indicating a requested transmission to a first user associated with a group of one or more devices, and select one or more of the devices included in the group of devices for receipt of one or more portions of the requested transmission based on the negotiated parameters.

According to another example embodiment, a request to a first user associated with a group of one or more devices may be received at a first server. One or more of the devices included in the group of devices may be selected for receipt of one or more portions of the request.

According to another example embodiment, a first request from a first user associated with a group of one or more devices may be received at a first server. A second request to a network node may be generated by the first server. A response may be received from the network node, wherein the response includes a third request. The third request may be distributed to one or more of the devices based on a determination that requested information is available from the one or more of the devices receiving the distributed third request.

### BRIEF DESCRIPTION OF THE DRAWINGS

FIG. 1 is a block diagram illustrating a communication network according to an example embodiment.

FIG. 2 is a block diagram illustrating an example communication network.

FIG. 3a is a flow chart illustrating operation of a node included a communication session according to an example embodiment.

FIG. 3b is a flow chart illustrating operation of a node included a communication session according to an example embodiment.

FIG. 4 is a flow chart illustrating operation of a server included in a communication session according to an example embodiment.

FIG. 5 is a flow chart illustrating operation of a node included a communication session according to an example embodiment.

FIG. 6 is a diagram illustrating operation of a communication session according to an example embodiment.

FIG. 7 is a diagram illustrating operation of a communication session according to an example embodiment.

FIG. 8 is a diagram illustrating operation of a communication session according to an example embodiment.

FIG. 9 is a diagram illustrating operation of a communication session according to an example embodiment.

FIG. 10 is a diagram illustrating operation of a communication session according to an example embodiment.

FIG. 11a is a flow chart illustrating operation of a node included a communication session according to an example embodiment.

FIG. 11b is a flow chart illustrating operation of a node included a communication session according to an example embodiment.

FIG. 12 is a block diagram illustrating an apparatus that may be provided in a network according to an example embodiment.

### DETAILED DESCRIPTION

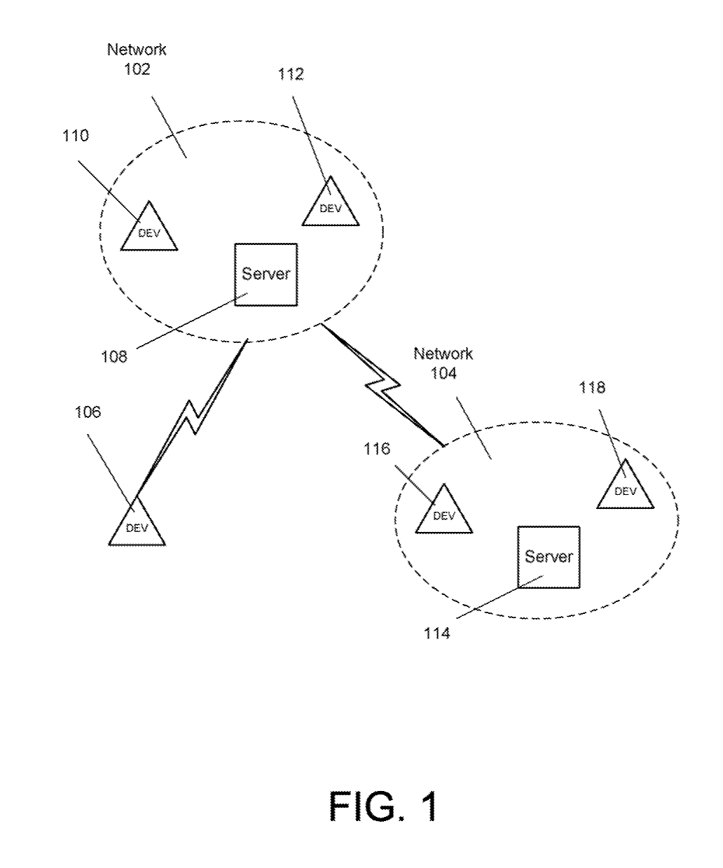

Referring to the Figures in which like numerals indicate like elements, FIG. 1 is a block diagram illustrating a communication network according to an example embodiment. The communication network may include one or more networks 102, 104, and it may include one or more devices such as a DEV 106. Each of the networks 102, 104 may be in communication with each other, and the DEV 106 may be in communication with either or both of the networks 102, 104.

Each of the networks 102, 104 may include a number of network nodes. For example, the network 102 may include a server 108 which may be in communication with one or more devices such as DEV 110 and DEV 112. Similarly, the network 104 may include a server 114 which may be coupled to one or more devices such as DEV 116 and DEV 118. The coupling may include one or more wired or wireless links. The networks 102, 104 may be wired or wireless networks, and may include a combination of wired and wireless communication techniques. The servers 108, 114 may include any type of server configured to communicate with the devices 106, 110, 112, 116, 118 using any type of communication, including Ethernet connectivity, TCP/IP, or any other type of communication connectivity. For example, the server 108 may include an application server (AS) located in a user's residence, the network 102 may include a local area network (LAN), and the devices 110, 112 may include fixed and/or mobile devices used by a user for multimedia reception and/or transmission. For example, DEV 110 may include a wireless personal digital assistant (PDA) configured to receive and transmit instructions from a user, and DEV 112 may include a television configured to display pictures and play audio based on transmissions received from the server 108. For example, the server 108 may be coupled to a fixed network, such as a Local Area Network (LAN), Wide Area Network (WAN), the Internet, etc., and may also be coupled to any other type of network or device, such as DEV 106.

The various embodiments described herein may be applicable to a wide variety of wired or wireless networks and technologies, such as WLAN networks (e.g., IEEE 802.11 type networks), IEEE 802.16 Wi MAX networks, cellular networks, radio networks, Global System for Mobile communications/third generation (GSM/3G) wireless networks with Internet Protocol (IP) Multimedia Subsystems (IMS) core networks, or other wired or wireless networks. The various embodiments described herein may be applied to wired and/or wireless networks.

The term “network node” or “node,” or server or device or the like, may include, for example, a wireless mobile device, an access point (AP), an application server (AS) or other Session Initiation Protocol (SIP) server, a conference server, a base station or other infrastructure node, a wireless personal digital assistant (PDA), an Internet phone, a cell phone, a television or other type of display device, an 802.11 WLAN phone, (voice) mail box, storage device, or any other user device or network device, wired and/or wireless. These are merely a few examples of the servers or devices that may be used to implement the various embodiments described herein, and this disclosure is not limited thereto.

As an example standard, the IETF Session Initiation Protocol (SIP) is an application-layer control (e.g., signaling) protocol for creating, modifying, and terminating sessions with one or more participants, as discussed below. For example, these sessions may include at least Internet telephone calls, multimedia distribution, and multimedia conferences.

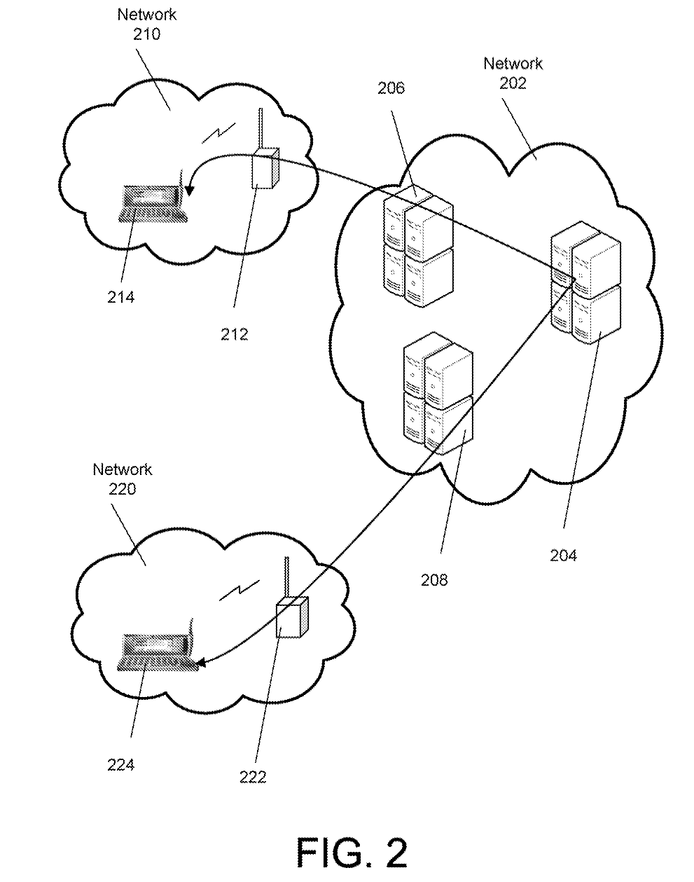

FIG. 2 is a block diagram illustrating an example communication network. More particularly, the example communication network shown in FIG. 2 may include a network 202 that may be configured, for example, as a SIP/IP core network (e.g., an IMS network) that may include servers 204, 206, and 208. The server 204 may include, for example, an application server (AS), and each of the servers 206, 208 may include SIP proxy servers coupled to the server 204 and other networks such as networks 210, 220, and other network nodes such as other devices (not shown). The network 210 may include, for example, a wireless local area network (WLAN) that may include a network node 212 coupled to a network node or device 214. The example network node 212 may include a WLAN server, an access point, or any other type of network device configured to communicate with the server 206 and the network node or device 214, via wired and/or wireless communication. As shown, the network node or device 214 may include a laptop or other type of computer.

The network 220 may include, for example, a cellular access network (e.g., GSM/3G) that may include a network node 222 coupled to a network node or device 224. The example network node 222 may include an access point, a server, or any other type of network device configured to communicate with the server 208 and the network node or device 224, via wired and/or wireless communication. As shown, the network node or device 224 may include a laptop or other type of computer.

As an example scenario, the server 204 may send invitations to the network nodes 212, 222 via the SIP proxy servers 206, 208 respectively, to invite the network nodes or devices 214, 224 to participate in a communication session. SIP invitations used to create sessions may include session descriptions that allow participants to agree on a set of compatible media types. The SIP proxy servers 206, 208 may be used at least to help route requests to a user's current location, authenticate and authorize users for services, implement provider call-routing policies, and provide features to users. A SIP registration function may provide users with a means to upload their current locations for use, for example, by the SIP proxy servers 206, 208. According to an example embodiment, SIP may be run on top of several different transport protocols.

Example Internet applications may involve the creation and management of sessions, wherein a “session” or a “communication session” may be considered as an exchange of data between an association of participants such as network nodes, for example, the servers 204, 206, 208 and/or the devices, servers or network nodes 212, 214, 222, 224. However, the implementation of these applications may be complicated by the practices of participants. For example, users of devices such as devices or network nodes 214, 224 may move between endpoints, they may be addressable by multiple names, or they may communicate in several different media, and the communication may occur simultaneously.

Example protocols have been proposed that may carry various forms of real-time multimedia session data such as voice, video, or text messages. SIP may work in concert with these protocols by enabling Internet endpoints, which may be referred to as user agents, to discover one another and to agree on a characterization of a session they would like to share. For locating prospective session participants, and for other functions, SIP may provide means for the creation of an infrastructure of network hosts, which may be referred to as proxy servers (e.g., the SIP proxy servers 206, 208), to which user agents may send registrations, invitations to communication sessions, and other requests. Thus, according to an example embodiment, SIP may be used for creating, modifying, and terminating sessions, and may work independently of underlying transport protocols and without dependency on the type of session that is being established.

Example working groups have also proposed example techniques for achieving session mobility. For example, a mobile node using SIP may discover available devices and include them in an active session. In order to accomplish this, a service location may be established, such that a user is aware of the devices which are available in his local area, along with their capabilities, at all times. Additionally, session mobility may be established, such that, while in a session with a remote participant, a user may transfer any subset of the active media services to one or more devices.

Instant Messaging (IM) is a form of two-way communications in which users may exchange information with others interactively. For example, users may exchange messages in near real time to engage in conversations. Such exchanges may, for example, rely on a low latency in the delivery of messages. For example, text messages may be exchanged; however, example enablers may support content types beyond text. Communications may be configured as one-to-one or one-to-many configurations, such that the messaging may occur between two individuals or within a group wherein everyone in the group may see what everyone else is sending. An example IM service may be configured to operate atop a SIP/IP core network (e.g., the network 202) as a SIP application. One example of such a network may include an IP Multimedia Subsystem (IMS) network such as the example network 202 of FIG. 2.

As an example scenario, a user may wish to participate in a communication session using several devices simultaneously. For example, a user of the device or network node 214 of FIG. 2 may wish to participate in a communication session with the server 204 via other devices or network nodes (not shown) such as a display screen for video transmission, a sound system for audio transmission accompanying the video transmission, and a computer such as the device or network node 214 for viewing the video transmission and listening to the audio transmission, for example, in a location that is different from the location of the other devices or network nodes. However, the user may further desire that the other parties of the communication (e.g., an example user of the device or network node 224) may see the user as only one party of the communication, regardless of the number of devices which may be actually used by the user for participating in the group communication. Alternatively, other users may lack capabilities or a desire to handle device specific issues associated with the user.

The Open Mobile Alliance (OMA) includes example protocols for using OMA Push to talk over Cellular (PoC) and instant messaging (IM) techniques. According to an example embodiment, for group communications or for a communication in which a network server may control the communication, an example user may either join in the communication by his initiative or the controlling server may invite the user for the communication, depending on circumstances of the communication. For example, a user of the device or network node 214 may join in a communication session by his initiative, or a controlling server such as the server 204 may invite the user for a communication session

According to an example embodiment, a semi-temporary device identifier may be used for identifying different devices. According to an example embodiment, Globally Routable User Agent URIs (GRUU) techniques, as specified by IETF, may support user agent specific addresses. Additionally, an OMA eXtensible Markup Language (XML) Document Management (XDM) enabler may provide additional functionality for example techniques described herein.

Example IETF techniques with regard to caller preferences and callee capabilities may provide guidance for IMS routing; however, a device may need to make a decision regarding limited usage within registration, and a user may prefer to assume that the same device may be used for different communications during the registration. Further, these example IETF techniques may not account for a user's preferences together with actual capabilities of one or more devices. Additionally, example IETF techniques for session mobility may support multiple devices and switching media components/sessions between them. However, example IETF techniques may specify a device specific (e.g., sub-network) approach instead of a network server based solution.

Example techniques for achieving session mobility using SIP may involve both transfer and retrieval of an active session. In this context, transfer of the session may involve moving the session on the current device to one or more other devices. Retrieval may involve remotely transferring a session currently on another device to a local device, and/or may involve returning a session to the device on which it had originally been before it was transferred to another device. For example, after discovering a large video monitor, a user may transfer a video output stream to that device. However, if the user walks away, he may return the stream to his mobile device for continued communication. A session may also be retrieved to a device that had not previously carried it. For example, a participant in an audio call on a stationary phone may leave his office in the middle of the call and transfer the call to a mobile device as he is leaving the office.

According to an example embodiment, session media may either be transferred completely to a single device or may be split across multiple devices. For example, a user may only wish to transfer the video of his session while maintaining the audio on his personal digital assistant (PDA). Alternatively, the user may obtain or locate separate video and audio devices and may wish to transfer one media service to each device. Further, even the two directions of a full-duplex session may be split across devices. For example, a display of a PDA may be too small for an acceptable view of other call participants, so the PDA user may transfer video output to a projector and continue to use the PDA camera.

According to an example embodiment, at least two different modes may be used for session transfer: Mobile Node Control (MNC) mode and Session Handoff (SH) mode. In Mobile Node Control Mode, a mobile device or network node may utilize third-party call control. The mobile device or network node may establish a SIP session with each device or network node used in the transfer and may update its session with a correspondent node (CN), using Session Description Protocol (SDP) parameters to establish media sessions between the CN and each device, which may take the place of the current media session with the CN. This example approach may require the mobile node (MN) to remain active to maintain the sessions.

According to an example embodiment, a user may need to transfer a session completely, for example, because the battery on his mobile device is running out. Alternatively, a user of a stationary device who leaves an area and wishes to transfer the session to his mobile device, may not want the session to remain on the stationary device when he is away, since others may easily tamper with his call while he is away from the stationary device. According to an example embodiment, a Session Handoff (SH) mode, which completely transfers the session signaling and media to another device, may be useful in such example scenarios.

According to an example embodiment, a communication session may include a number of media types, and a user may be able to transfer any of them to his device or network node of choice. Examples of media types may include, at least, audio, video and messaging. For example, audio and video may be carried by Real-time Transport Protocol (RTP) and may be negotiated in a Session Description Protocol (SDP) body of the SIP requests and responses. For the transfer of text or multimedia messages, an example SIP MESSAGE method or an example Message Session Relay Protocol (MSRP) may be used, although the present discussion is not limited only to these techniques.

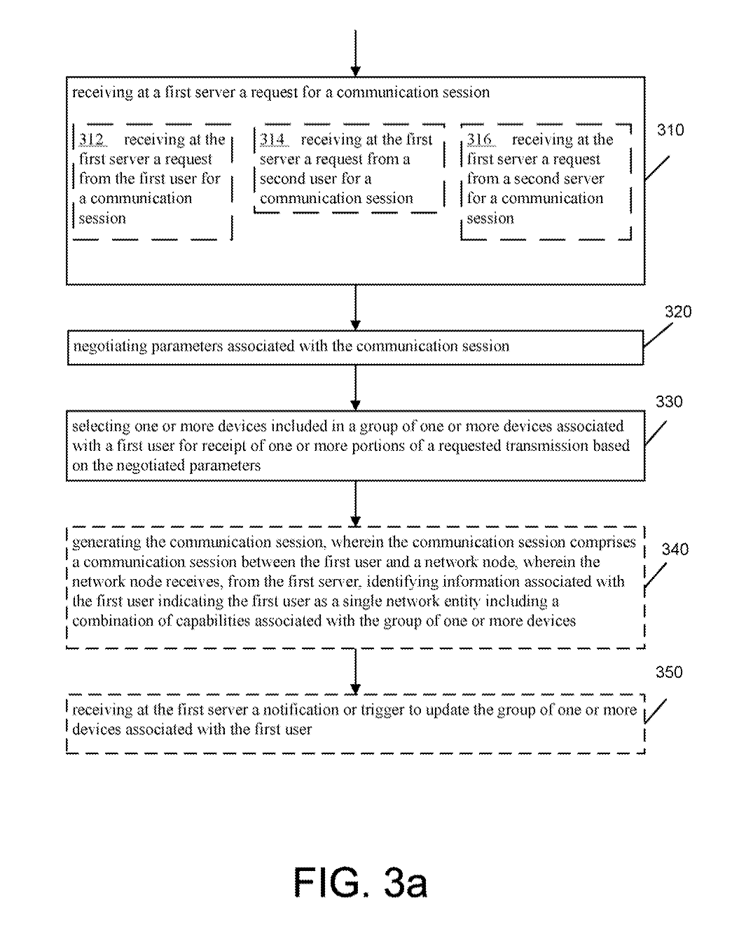

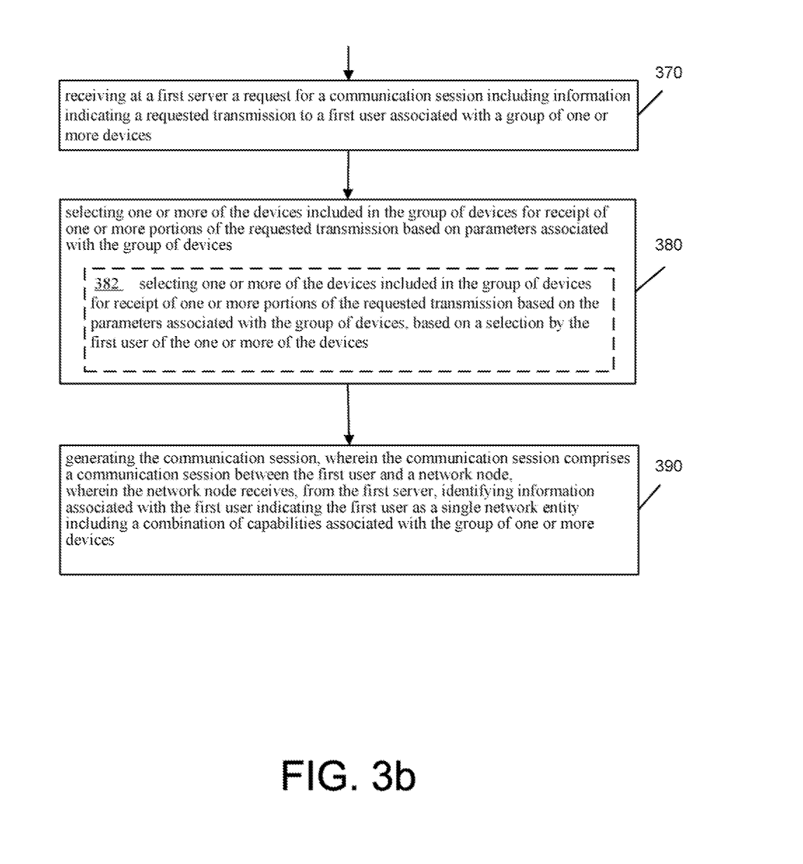

FIG. 3a is a flow chart illustrating operation of a network node included in a communication session according to an example embodiment. A request for a communication session may be received at a first server (310). According to an example embodiment, the first server may include an application server (AS). For example, the AS may reside at a user's residence. According to an example embodiment, the communication session may include a SIP communication session. According to an example embodiment, the request for a communication session may include a SIP INVITE message. According to an example embodiment, the server 108 of FIG. 1 may receive a SIP INVITE message.

According to an example embodiment, the request for a communication session may be received at the first server from the first user (312). For example, the request for a communication session (e.g., a SIP INVITE message) or other request for communication (e.g., SIP MESSAGE) may be received at the server 108 from a user of the devices or network nodes 110, 112. According to an example embodiment, a SIP MESSAGE request may be used to send a single user message, for example, a text message.

According to an example embodiment, the request for a communication session may be received at the first server from a second user (314). For example, the request for a communication session (e.g., a SIP INVITE message) or other request for communication (e.g., SIP MESSAGE) may be received at the server 108 from a user of the device or network node 106.

According to an example embodiment, the request for a communication session may be received at the first server from a second server (316). For example, the request for a communication session (e.g., a SIP INVITE message) or other request for communication (e.g., SIP MESSAGE) may be received at the server 108 from the server 114.

According to an example embodiment, an initial request for a communication session may include an offer of session parameters and a potential “list of mandatory to support” parameters/features.

According to an example embodiment, the SIP INVITE message may be received from the server 114 or from the device or network node 106. According to an example embodiment, the SIP INVITE message may be received from the device or network node 110.

According to an example embodiment, parameters associated with the communication session may be negotiated (320). For example, the first server may include an AS, and the AS may negotiate parameters associated with one or more devices included in a group of devices associated with a user so that particular types of media content may be transmitted to/from each device appropriately. According to an example embodiment, the server 108 may negotiate parameters associated with the devices or network nodes 110, 112. According to an example embodiment, the server 114 may negotiate parameters associated with the communication session with the server 108. According to an example embodiment, the server 108 may negotiate parameters associated with the communication session with the device or network node 106.

According to an example embodiment, a negotiation may include a selection, by another party of the communication session, of parameters to be used for the communication session, from a set of offered parameters as discussed previously. Alternatively, the other party may reject the request with an indication of supported parameters/features by the other party so that, for example, an initiator of the request may re-initiate the request. According to an example embodiment, a negotiation of parameters and an analysis of a user's available devices and a selection of devices may occur simultaneously, such that the end result of the negotiation may depend on the selected set of devices and their capabilities.

According to an example embodiment, negotiation may have occurred earlier and the server 108 (e.g., an AS) may already have information regarding device capabilities (and potentially other information) when the request for the communication session is received. According to an example embodiment, an example IETF mechanism “callee capabilities” may be used to communicate device capabilities in the device registrations and information would be then available at the server 108 (e.g., an AS). In such a scenario, the server 108, or AS may not need explicit negotiations with the devices but may send the request for the communication session to a device having better matching capabilities for the communication session request (e.g., video support).

According to an example embodiment, the request for a communication session may include a request for a communication session between the first user and a network node. According to an example embodiment, the request for a communication session may include a request for a communication session between the first user and a second server. For example, the request for a communication session (e.g., a SIP INVITE message) or other request for communication (e.g., SIP MESSAGE) may include a request for a communication session between the first user (e.g. a user of the devices or network nodes 110, 112) and the server 114. According to an example embodiment, the second server may include one or more of a conference server, a group communication server, a controlling server, or an application server.

According to an example embodiment, the request for a communication session may include a request for a communication session between the first user and a second user. For example, the request for a communication session may include a request for a communication session between the first user (e.g. a user of the devices or network nodes 110, 112) and a user of the device or network node 106. As another example, the request for a communication session may include a request for a communication session between the first user (e.g. a user of the devices or network nodes 110, 112) and a user of one of the devices or network nodes 116, 118.

According to an example embodiment, receiving at the first server the request for a communication session may include receiving at an application server (AS) an invitation associated with the communication session between the first user and a network node, and negotiating parameters associated with the communication session may include negotiating, between the AS and one or more of the devices included in the group of devices, parameters associated with the communication session. For example, the parameters may include values of device characteristics associated with the devices or network nodes 110, 112. For example, the parameters may include the types of transmissions that the devices are configured to handle (e.g., particular types of audio or video transmissions) and corresponding attribute values associated with the transmission types (e.g., speed or frequency).

According to an example embodiment, the invitation may be sent to the one or more of the devices included in negotiating the parameters. For example, the invitation (e.g., SIP INVITE) may be sent to the devices or network nodes 110, 112, if they were included in negotiating the parameters.

According to an example embodiment, receiving at the first server the request for a communication session may include receiving from the first user at an application server (AS) an invitation associated with the communication session, and negotiating parameters associated with the communication session may include negotiating, between the first user and one or more of the devices included in the group of devices, parameters associated with the communication session. For example, the invitation (e.g., SIP INVITE) may be received from a user of the devices or network nodes 110, 112 at a server 108, and the parameters may be negotiated between the user and one or more of the devices or network nodes 110, 112 included in the group. According to an example embodiment, the invitation may be sent to a network node. For example, the invitation may be sent to the server 114. According to an example embodiment, the network node may include a second server or a second user.

According to an example embodiment, receiving at the first server the request for a communication session may include receiving from the first user at an application server (AS) an invitation associated with the communication session. According to an example embodiment, a group of parameters associated with the first user may be generated based on combining parameters associated with the one or more devices included in the group of devices and the invitation may be sent to a network node. For example, the group of parameters may be generated based on combining the parameters associated with one or more of the devices or network nodes 110, 112, and the invitation may be sent to the server 114. Thus, for example, the parameters of the devices or network nodes 110, 112 may be combined so that the user of the devices or network nodes 110, 112 may be represented by the server 108 as a single network entity to other network nodes such as network nodes external to the network 102, instead of being represented as multiple devices or network nodes.

According to an example embodiment, negotiating parameters associated with the communication session may include negotiating, between the AS and the network node, one or more parameters associated with the communication session, based on one or more of: the group of parameters associated with the first user, a group of parameters supported by the network node, a group of parameters supported by a service or an application executed by the network node, a group of parameters supported by an operator operating a network wherein the first server is located, or a group of parameters negotiated with users other than the first user. For example, the server 108 may negotiate one or more of the combined parameters with the server 114 based on the group of parameters associated with the first user. Thus, the servers 108 and 114 may negotiate only parameters associated with the represented single network entity instead of negotiating parameters separately for each device or network node 110, 112.

One or more devices included in a group of one or more devices associated with a first user may be selected for receipt of one or more portions of a requested transmission based on the negotiated parameters (330). For example, an AS may select one or more of the devices for transmission of information, based on the negotiated parameters. For example, the server 108 may select one or more of the devices or network nodes 110, 112 for receipt of one or more portions of the requested transmission based on the parameters. For example, the server 108 may receive transmissions of information from the server 114, and may then determine which devices included in the group of devices or network nodes 110, 112 should receive one or more portions of the received transmissions. For example, the server 108 may send a video stream to a first one of the devices, and an associated audio stream simultaneously to a second one of the devices. For example, the server 108 may “split” a received transmission to send the transmission simultaneously to two separate devices, for example, to a PDA and to a television receiver.

According to an example embodiment, a transmission associated with a group of media components and an indicator associated with the first user may be received at the first server. According to an example embodiment, the group of media components may be sent from the first server to the one or more devices included in the group of devices selected for receipt of one or more portions of the transmission based on the negotiated parameters, based on the selecting. For example, the server 108 may receive a message associated with a group of media components such as audio and video components, and an indicator identifying an intended recipient of the components as the first user, represented by the server 108 as a single network entity. For example, the server 108 may send a video stream to a first one of the devices, and an associated audio stream simultaneously to a second one of the devices. For example, the server 108 may “split” a received transmission to send the transmission simultaneously to two separate devices, for example, to a PDA and to a television receiver.

According to an example embodiment, the transmission may include a Message Session Relay Protocol (MSRP) transmission or a Real-time Transport Protocol (RTP) transmission.

According to an example embodiment, the first server may select one or more of the devices included in the group of devices for receipt of one or more portions of the requested transmission based on the negotiated parameters. For example, the server 108 may send a video stream to a first one of the devices, and an associated audio stream simultaneously to a second one of the devices based on the negotiated parameters.

According to an example embodiment, one or more of the devices included in the group of devices may be selected for receipt of one or more portions of the requested transmission based on the negotiated parameters, based on a selection by the first user of the one or more of the devices. For example, the first user may select the device or network node 110 to receive video transmissions, and the device or network node 112 to receive audio transmissions.

According to an example embodiment, one or more of the devices included in the group of devices may be selected for receipt of one or more portions of the requested transmission based on parameters associated with the group of devices, based on a selection by the first user of the one or more of the devices.

According to an example embodiment, the request for the communication session may be sent to each of the devices included in the group of devices, an acceptance of at least a portion of the communication session, may be received from the first user, wherein the acceptance may indicate one or more of the devices included in the group for the receipt of the one or more portions of the requested transmission, and session parameters associated with the communication session may be negotiated based on the parameters associated with the group of devices.

According to an example embodiment, parameters associated with the group of devices may be determined at the first server based on device registration information, one or more devices included in the group of devices may be determined for receipt of the request for the communication session based on the determined parameters associated with the group of devices, the request for the communication session may be sent to each of the determined devices included in the group of devices, and session parameters associated with the communication session may be negotiated based on parameters associated with the determined devices included in the group of devices.

According to an example embodiment, parameters associated with the group of devices may be determined at the first server based on device information provided by the first user and stored at a second server, one or more devices included in the group of devices may be determined for receipt of the request for the communication session based on the determined parameters associated with the group of devices, the request for the communication session may be sent to each of the determined devices included in the group of devices, and session parameters associated with the communication session may be negotiated based on parameters associated with the determined devices included in the group of devices.

According to an example embodiment, a request for a communication session including information indicating a requested transmission to the first user associated with the group of one or more devices and an identifier associated with a predetermined one of the devices included in the group of devices may be received at the first server, and the request for the communication session may be sent to the predetermined one of the devices based on the identifier.

According to an example embodiment, a transmission associated with a group of one or more media components and based on the selecting and the negotiated parameters may be received at the first server, and the group of media components may be sent from the first server to the storage device for storage. For example, the device or network node 112 may include a storage device such as a hard drive, and the server 108 may receive a message with an indicator identifying a receiving storage device, based on the negotiated parameters, and the server 108 may send the media components associated with the received message to the device or network node 112 for storage. A sender of the message need not know exactly what device the media components will be stored on, as the server 108 may handle the device-specific details after receiving a message directed to the single network entity representation of the user and associated devices or network nodes 110, 112.

According to an example embodiment, the communication session may be generated, wherein the communication session includes a communication session between the first user and a network node, wherein the network node receives, from the first server, identifying information associated with the first user indicating the first user as a single network entity including a combination of capabilities associated with the group of one or more devices (340). For example, the network node may only “see” the first user and its associated devices or network nodes 110, 112 as a single party or presence associated with parameters that may be associated with the devices that are associated with the user. Thus, the network node, any intermediary conference servers, and other users such as a second user may only “see” the first user and its associated devices as a single party to the communication session, and may be unaware of the specific devices included in the group of devices. Thus, the server 108 may represent a user associated with the devices or network nodes 110, 112 as a single network entity to the server 114 and/or the device or network node 106, who may be unaware of the specific devices 110, 112 based on the representation presented by the server 108.

According to an example embodiment, a notification or trigger to update the group of one or more devices associated with the first user may be received at the first server (350). For example, a user of the devices or network nodes 110, 112 may send a notification to the server 108 to update the group of devices. For example, the user may notify the server 108 to delete or add one or more devices. For example, the user may notify the server 108 to modify the parameters associated with the devices. For example, the user may notify the server 108 to modify parameters associated with the device or network node 110 from parameters for audio transmissions to updated parameters for video or text transmissions. According to an example embodiment, the first user may switch on one of the devices in the group, which may serve as a trigger for the server 108 to update the group of devices to include the newly activated device in the communication session. According to an example embodiment, a need for updating parameters associated with a communication session may be triggered by an external node. According to an example embodiment, the combination of capabilities associated with the single network entity may be modified based on the notification to update the group of devices. For example, the server 108 may modify the combination of capabilities associated with the single network entity based on the notification to update. For example, the server 108 may modify the capabilities to reflect a notification by the user to modify parameters associated with the device or network node 110 from parameters for audio transmissions to updated parameters for video or text transmissions. The server 108 may then handle transmissions to and from the devices 110, 112 in accordance with the updated parameters, and network nodes external to the example network 102 may continue to “see” the user as a single network entity having the modified capabilities.

According to an example embodiment, the update may be associated with one or more of media in use, one or more media parameters, content types supported by media, or media features.

According to an example embodiment, a notification from the first user to update the group of one or more devices associated with the first user may be received at the first server.

According to an example embodiment, a trigger from a network node to update the group of one or more devices associated with the first user may be received at the first server.

According to an example embodiment, the combination of capabilities associated with the single network entity may be modified based on the notification or trigger to update the group of devices.

According to an example embodiment, information indicating a requested transmission to the first user may be received at the first server.

FIG. 3b is a flow chart illustrating operation of a network node included in a communication session according to an example embodiment. A request for a communication session including information indicating a requested transmission to a first user associated with a group of one or more devices may be received at a first server (370). According to an example embodiment, the first server may include an application server (AS). For example, the AS may reside at a user's residence. According to an example embodiment, the communication session may include a SIP communication session. According to an example embodiment, the request for a communication session may include a SIP INVITE message. According to an example embodiment, the server 108 of FIG. 1 may receive a SIP INVITE message.

One or more of the devices included in the group of devices may be selected for receipt of one or more portions of the requested transmission based on parameters associated with the group of devices (380). According to an example embodiment, one or more of the devices included in the group of devices may be selected for receipt of one or more portions of the requested transmission based on the parameters associated with the group of devices, based on a selection by the first user of the one or more of the devices (382).

The communication session may be generated, wherein the communication session includes a communication session between the first user and a network node, wherein the network node may receive, from the first server, identifying information associated with the first user indicating the first user as a single network entity including a combination of capabilities associated with the group of one or more devices (390).

According to an example embodiment, the request for the communication session may be sent to each of the devices included in the group of devices. According to an example embodiment, an acceptance of at least a portion of the communication session may be received from the first user, wherein the acceptance may indicate one or more of the devices included in the group for the receipt of the one or more portions of the requested transmission. According to an example embodiment, session parameters associated with the communication session may be negotiated based on the parameters associated with the group of devices.

According to an example embodiment, the parameters associated with the group of devices may be determined at the first server based on device registration information. According to an example embodiment, one or more devices included in the group of devices may be determined for receipt of the request for the communication session based on the determined parameters associated with the group of devices. According to an example embodiment, the request for the communication session may be sent to each of the determined devices included in the group of devices. According to an example embodiment, session parameters associated with the communication session may be negotiated based on parameters associated with the determined devices included in the group of devices.

According to an example embodiment, the parameters associated with the group of devices may be determined at the first server based on device information provided by the first user and stored at a second server. According to an example embodiment, one or more devices included in the group of devices may be determined for receipt of the request for the communication session based on the determined parameters associated with the group of devices. According to an example embodiment, the request for the communication session may be sent to each of the determined devices included in the group of devices, and session parameters associated with the communication session may be negotiated based on parameters associated with the determined devices included in the group of devices. For example, the first server may determine which device(s) the request may be sent to based on user specified device or user preference information available from an XDM or Presence server, as discussed further below. According to an example embodiment, detailed session parameters may be negotiated and a session may be established.

According to an example embodiment, the request for the communication session including information indicating a requested transmission to a first user associated with a group of one or more devices and an identifier associated with a predetermined one of the devices included in the group of devices, may be received at the first server. According to an example embodiment, the request for the communication session may be sent to the predetermined one of the devices based on the identifier. For example, the request for the communication session may include a unique device identifier GRUU, and the request may be routed to a particular device based on the unique device identifier.

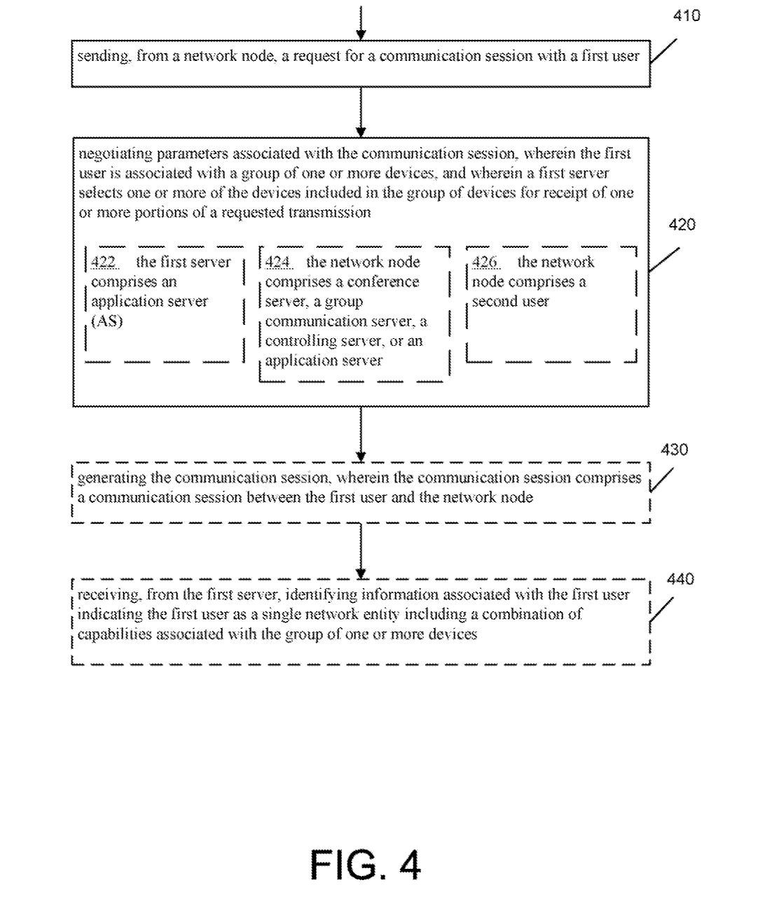

FIG. 4 is a flow chart illustrating operation of a network node included a communication session according to an example embodiment. At 410, a request for a communication session with a first user may be sent from a network node. For example, the request for a communication session may be sent from the device or network node 106, or from the server 114 or one of the devices or network nodes 116, 118. According to an example embodiment, the communication session may include a Session Initiation Protocol (SIP) communication session.

According to an example embodiment, parameters associated with the communication session may be negotiated, wherein the first user is associated with a group of one or more devices, and wherein a first server may select one or more of the devices included in the group of devices for receipt of one or more portions of a requested transmission (420). For example, the server 114 or the device or network nodes 106 may negotiate the parameters with the server 108.

For example, the server 114 or the device or network node 106 may send, to the server 108, the information indicating the requested transmission to the first user. The server 108 may then select one or more of the devices 110, 112 for receipt of one or more portions of the requested transmission based on the negotiated parameters. For example, the server 108 may send an audio portion of the transmission to the device or network node 110, and a video portion to the device or network node 112 based on the negotiated parameters. Thus, the sending network node is unaware of the specific devices 110, 112, as the server 108 handles the determination of routing the transmissions.

For example, the network node may send, to the server 108, information indicating a requested transmission including multiple media types to the first user, as the network node may be unaware of the specific devices included in the group of devices, but may be aware of parameters associated with the devices based on the negotiation.

According to an example embodiment, the first server may include an application server (AS) (422). For example, the first server may include the server 108.

According to an example embodiment, the network node may include a conference server, a group communication server, a controlling server, or an application server (424). For example, the network node may include the server 114.

According to an example embodiment, the network node may include a second user (426). For example, the network node may include the device or network node 106.

According to an example embodiment, the communication session may be generated, wherein the communication session comprises a communication session between the first user and the network node (430). For example, the communication session may be generated between a user of the devices or network nodes 110, 112 and the server 114 or the device or network node 116 or the device or network node 106. As another example, the communication session may be generated as a group communication session (one-to-many) or as a one-to-one session.

According to an example embodiment, identifying information associated with the first user indicating the first user as a single network entity including a combination of capabilities associated with the group of one or more devices may be received from the first server (440).

For example, the network node may receive identifying information indicating that the first user indicated as a single network entity is associated with certain parameters that may be associated with the devices in the group; however, the network node may not need to know which specific devices are included in the group of devices, and may thus only “see” the first user as a party or presence.

According to an example embodiment, the first server and the network node may be included in a Third Generation Partnership Project, 3GPP/3GPP2 network.

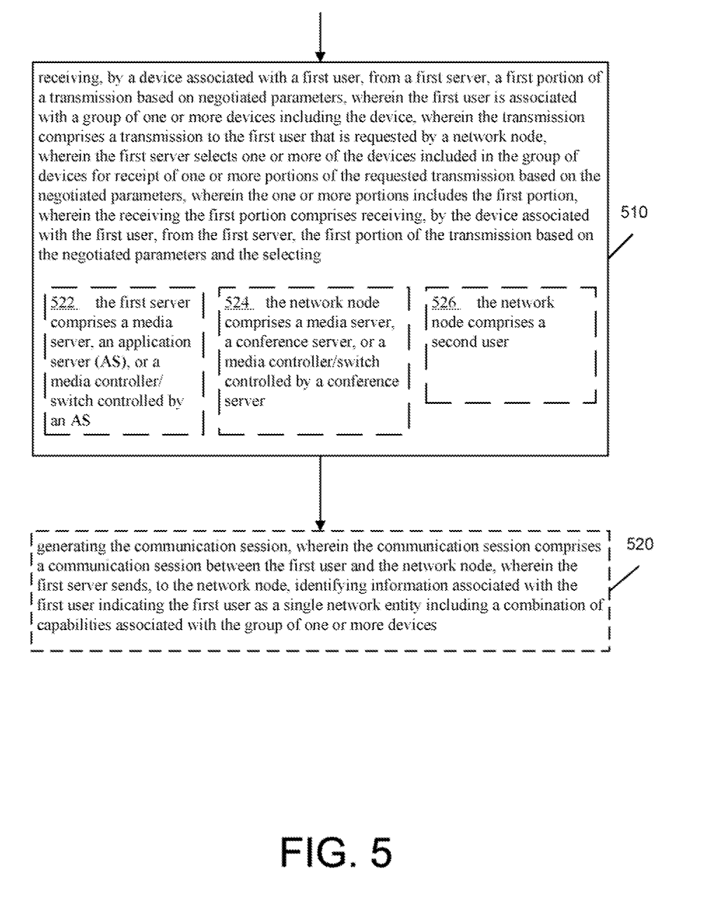

FIG. 5 is a flow chart illustrating operation of a node included a communication session according to an example embodiment. A first portion of a transmission may be received by a device associated with a first user, from a first server, based on negotiated parameters, wherein the first user is associated with a group of one or more devices including the device, wherein the transmission comprises a transmission to the first user that is requested by a network node, wherein the first server selects one or more of the devices included in the group of devices for receipt of one or more portions of the requested transmission based on the negotiated parameters, wherein the one or more portions includes the first portion, wherein the receiving the first portion comprises receiving, by the device associated with the first user, from the first server, the first portion of the transmission based on the negotiated parameters and the selecting (510). For example, a user associated with the devices or network nodes 110, 112 may negotiate, with the devices or network nodes 110, 112, parameters associated with a communication session. According to an example embodiment, the communication session may include a SIP communication session.

For example, the server 108, such as an application server (AS), may reside at the user's network such as a home network. For example, the user may wish to engage in a communication session such as a SIP session with another network node such as the server 114 or the device or network node 106 or the device or network node 116 or 118. According to an example embodiment, the server 114 may include a conference server.

According to an example embodiment, an invitation associated with the communication session may be received at a server such as the server 108. For example, the user may initiate the invitation. For example, the invitation may include a SIP INVITE message.

For example, the server 108 may receive a transmission to the first user that is requested by a network node, and may select one or more of the devices included in the group of devices for receipt of one or more portions of the requested transmission based on the negotiated parameters, and may send a first portion of the transmission to the device or network node 110 based on the negotiated parameters, as discussed previously.

According to an example embodiment, the first server may include a media server, an application server (AS), or a media controller/switch controlled by an AS (522). For example, the first server may include the server 108.

According to an example embodiment, the network node may include a media server, a conference server, or a media controller/switch controlled by a conference server (524). For example, the network node may include the server 114.

According to an example embodiment, the network node may include a second user (526). For example, the network node may include the device or network node 106, the device or network node 116, or the device or network node 118.

For example, a user of the devices or network nodes 110, 112 may negotiate, with the server 108, parameters associated with one or more of the devices or network nodes 110, 112 so that particular types of media content may be transmitted to/from each device appropriately. For example, a network node external to the network 102 may only “see” the user as a single party or presence associated with parameters that may be associated with the devices that are associated with the user. Thus, the network node and any intermediary conference servers may only “see” the user as a party to the communication session, and may be unaware of the specific devices or network nodes 110, 112.

According to an example embodiment, the communication session may be generated, wherein the communication session may include a communication session between the first user and the network node, wherein the first server may send, to the network node, identifying information associated with the first user indicating the first user as a single network entity including a combination of capabilities associated with the group of one or more devices (520). For example, the server 108 may send, to the network node, identifying information associated with the user of the devices or network nodes 110, 112 indicating the user as a single network entity including a combination of capabilities associated with the devices or network nodes 110, 112. The receiving network node may not be aware of the specific devices or network nodes 110, 112.

For example, as discussed previously, the server 108 may receive transmissions of information from the network node, and may then determine which devices included in the group of devices should receive one or more portions of the received transmissions.

Example invitations sent by network nodes may include SIP INVITE messages. An example SIP INVITE message is shown below.

Example SIP INVITE message

```
INVITE sip:bob@biloxi.example.com SIP/2.0
  To: <sip:bob@biloxi.example.com>
  From: <sip:alice@atlanta.example.com>;tag=786
  Call-ID: 3413an89KU
  CSeq: 314159 INVITE
  Contact: <sip:alice@pc33.atlanta.com>;gr=kjh29x97us97d
  Content-Type: application/sdp
  c=IN IP4 atlanta.example.com
  m=message 7654 TCP/MSRP *
  a=accept-types:text/plain
  a=path:msrp://atlanta.example.com:7654/jshA7weztas;tcp
```

As shown in the SIP INVITE message, URI's are specified indicating a “To” path and a “From” path, as well as other information identifying the parties to the communication. Thus, a user “bob” is being invited to a session by a user “alice.” As shown, the message indicates an INVITE message, which may be accepted via an MSRP path shown on the last line.

According to an example embodiment, other types of SIP messages may be used by the network nodes. For example, a SIP event notification mechanism may use NOTIFY messages to signal when certain telephony events take place. For example, a notification may include a notifier sending a NOTIFY message to a subscriber to inform the subscriber of the state of a resource. For example, a SIP SUBSCRIBE method may be used to request current state and state updates from a remote node.

Example techniques described herein may provide a means for a user to participate in communications such as group communications using several devices simultaneously such that the other parties of the communication may see the user as only one party of the communication regardless of the actual number of devices used by the user for the communication. As an example, a user may wish to use several devices in order to use different media components in different devices. The user may also wish to use network storage, for example, as one of the devices, to store some specific media components which may not be received with a terminal used currently for the communication.

For example group communications, a “controlling server,” for example, the server 114 discussed previously, which may be referred to herein as a “focus” or conferencing/chat server, may manage the distribution of requests and media to participants of the communication, or, for example, may share participant information to all parties of the communication. For example, the controlling server may manage unique nicknames associated with the participants. However, it may be desirable that a controlling server (e.g., which may reside in a different network) not bear the responsibility or handle such device specific issues. Additionally, an operator policy or group communication policy may include restrictions regarding participants of the communications, for example, for controlling load. In this case, it may be inconvenient and/or unacceptable that one user reserves more than a predetermined amount of communication resources.

It may be desirable that a particular user's multiple device usage and changes in usage may be invisible to “outside entities” such as other users and a controlling server involved in the communication. For example, it may be desirable that the multiple device usage of the user of the devices or network nodes 110, 112 be invisible to the network nodes external to the example network 102. Furthermore, example conventional OMA IM and PoC architectures may include a participating server entity such as the example server 108 residing on a user's home network, handling access policies/request filtering, storing of messages and conversation histories. Assuming that all the user's devices receive separate requests, the terminating participating server (e.g., the server 108) may need to provide multiple entity functionality with regard to one regular request (e.g., compared to a scenario wherein only one device is used by the user). As a result, signaling toward the participating server may increase, and the requests may be stored or recorded multiple times.

Furthermore, with initial requests, an originator of the request (e.g., the originating user or the conference server) may not be able to determine which devices the user may want to use for receiving the request, or how to use those devices for the communication, as the user's desires may be based on various factors such as time/weekday, used media vs. available media in a device, originator's identity, user's willingness, charging, user's other parallel activities, user's location and environment, etc. Additionally, the policies of an operator of a home network may affect which devices may be used, or how certain devices may be used.

Example conventional Open Mobile Alliance (OMA) Converged IP Messaging (CPM) descriptions and corresponding use cases may include one or more of the following:
1) A CPM enabler may notify the arrival of a new CPM session request to all or a subset of the devices on which the CPM user is registered dependent upon the user's preferences, device capabilities and/or operator's settings.
2) A CPM enabler may allow a CPM user to use multiple devices for a single CPM session.
3) In dynamic session modification operations, a CPM enabler may allow a CPM user to choose which devices he/she will use for the added/modified media. Thus, a session modification may be initiated externally or by a user. According to an example embodiment, already-negotiated session parameters (e.g., media parameters or media components) may be modified, for example, by a conferencing server such as the server 604. Thus, a similar principle may be applied to the session modification operations as to a normal communication session initiation regarding the server 602.
4) A CPM enabler may allow a CPM user to switch a CPM session from one device to another device without any interruption of the conversation.

According to an example embodiment, a server such as a SIP Application Server (AS), for example, residing in a terminating user's home network, may handle decisions regarding how received requests are delivered and different media components are to be shared among different devices based on the user's preferences and other available information. For example, the server 108 discussed previously may handle such decisions.

The example AS may also handle hiding multiple devices used by the user from other (e.g., outsider) entities of the network. Thus, the AS may show to the other entities requests initiated by the user from several devices as if the requests were sent from one device within a communication session. The AS may also combine responses from several devices, and handle the transmission of only one individual SIP request, for example, a SIP SUBSCRIBE message, for participant information.

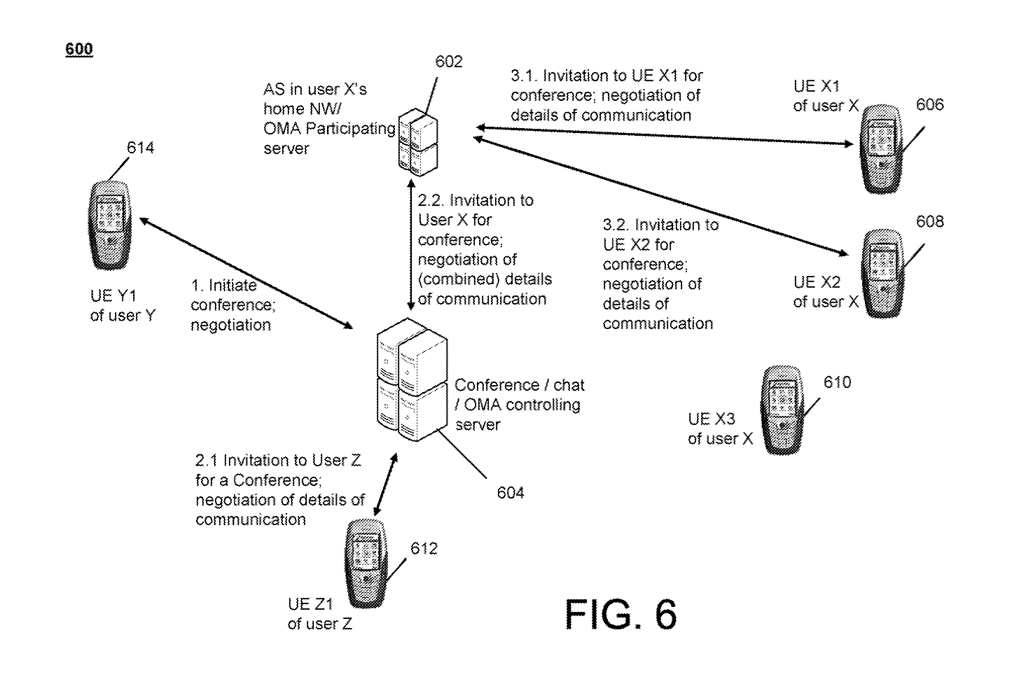

FIG. 6 is a diagram illustrating operation of a communication session according to an example embodiment. FIG. 6 depicts an example scenario 600 in which a user may receive an invitation for communication according to an example embodiment. For example, a user may receive a SIP INVITE message.

As shown in FIG. 6, an example server 602 (e.g., similar to the server 108 of FIG. 1) may include an AS that may be located in an example user X's home network, and include an OMA participating server in a network. An example server 604 (e.g., similar to the server 114 of FIG. 1) may include an example conference/chat/controlling server such as a server 604 that may communicate with the server 602. The user X may be associated with one or more devices or network nodes, such as a user equipment (UE) device X1 606, a UE device X2 608, and a UE device X3 610, that may communicate with the server 602.

A user Z may be associated with a network node or UE device Z1 612, and a user Y may be associated with a network node or UE device Y1 614, which may communicate with the server 604. The example server 602 may be triggered on a terminating side, and may be responsible for handling: 1) distribution of an invitation (e.g., a SIP INVITE) to, and negotiating of media with, multiple registered devices of a user such as the user X, and/or 2) distribution of the invitation based on one or more pre-defined user preferences, or predetermined terminal capabilities and service and/or service registration status. For example, the server 602 may handle these tasks with regard to the UE devices 606, 608, 610 associated with user X. In order to handle these example functions, the server 602 (e.g., an AS) may split an example Session Description Protocol (SDP) of an incoming request in order to offer different media components to different devices. The example server 602 may also need to know other information such as information regarding which devices are available.

Thus as shown in FIG. 6, multiple devices may be included in a communication session, for example, associated with the user X, and the invitations to a conference with the user Y via the UE device 614 may be generated by the server 604.

According to the example scenario 600 shown in FIG. 6, the UE device Y1 614 sends a message to the Conference/chat/OMA controlling server 604 that indicates a request “1. Initiate conference” including offered session parameters and an identifier of a predetermined conference or a potential list of invited participants. Thus, the user Y may request the server 604 to initiate a conference or communication session, and negotiate any parameters needed for such a conference.

The server 604 may then send an invitation to the UE device Z1 612 and negotiate parameters associated with the conference requested by the user Z. The server 604 may also send an invitation to user X, which may be routed via the server 602 inviting user X to the conference. The servers 602 and 604 may then negotiate parameters associated with a presence associated with the user X, so that combined parameters associated with the combination of devices 606, 608, and 610 may be negotiated by the server 602 on behalf of the user X. The server 604 may be unaware of the specific devices 606, 608, 610, and may only be aware of capabilities of the devices associated with the user X via the presence.

Thus, the server 602 may send an invitation to the UE device X1 606 for a conference, and may negotiate of details of the communication with the UE device X1 606. Similarly, the server 602 may send an invitation to the UE device X2 608 for a conference, and may negotiate of details of the communication with the UE device X2 608. As shown in the example scenario of FIG. 6, the UE device X3 610 may not be needed for the conference, and may thus not receive an invitation to join the communication session. However, according to an example embodiment, if the UE device X3 610 includes capabilities that may be needed as the conference proceeds, the communication session may be modified to include the UE device X3 610.

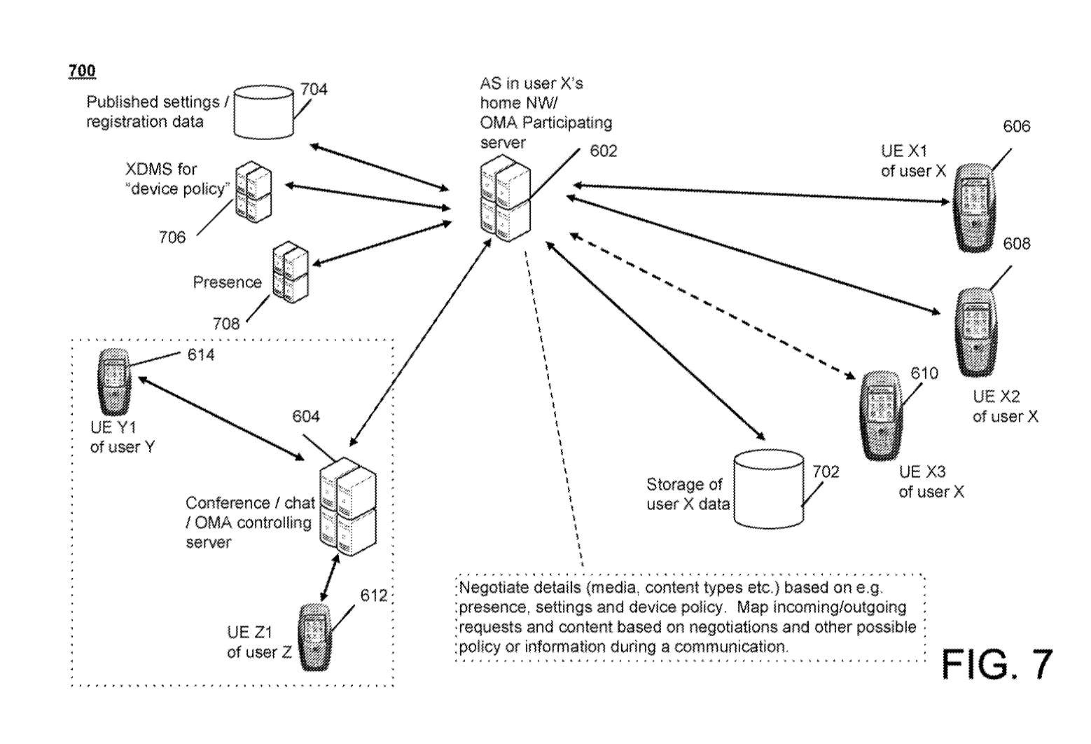

FIG. 7 is a diagram illustrating operation of a communication session according to an example embodiment. As shown in FIG. 7, a storage device 702 may be provided, for example, for storage of data associated with communications of the user X discussed previously with regard to FIG. 5. According to an example embodiment, the storage device 702 may store/record communication requests. Additionally, a storage device 704 may be provided for storage of published settings and/or registration data, for example, for use by the server 602 in negotiations involved in establishing communication sessions or conferences between the user X and other network entities (e.g., network nodes). For example, device parameters, such as device characteristics or attributes (e.g., video capabilities, audio capabilities, storage capacity, speed, frequency, etc.) associated with each of the devices 606, 608, 610 may be stored in the storage device 704 for access by the server 602 during negotiations. Further, a server 706 may be provided, for example, and may include an eXtensible Markup Language (XML) Document Management Server (XDMS) to handle user-specific predetermined rules and/or policies related to devices included in the network. Such policies may be considered during the negotiations of the parameters associated with the communication sessions or conferences. Additionally, a server 708 may include a presence server to handle information for transmission to the individual devices 606, 608, 610, and information associated with the combination of devices, or the presence of the user X, for transmission to the example server 602 and other network entities that may engage in communication with the user X.

Thus, according to an example embodiment, the negotiation of the parameters may be based on media, content types, and other features associated with the parties to the communication session, and may be based on presence, settings and device policies. As a result, example incoming/outgoing requests and content may be mapped by the example server 602 to example network nodes or devices such as wired or wireless network nodes based on negotiations and other possible policy or information during a communication.

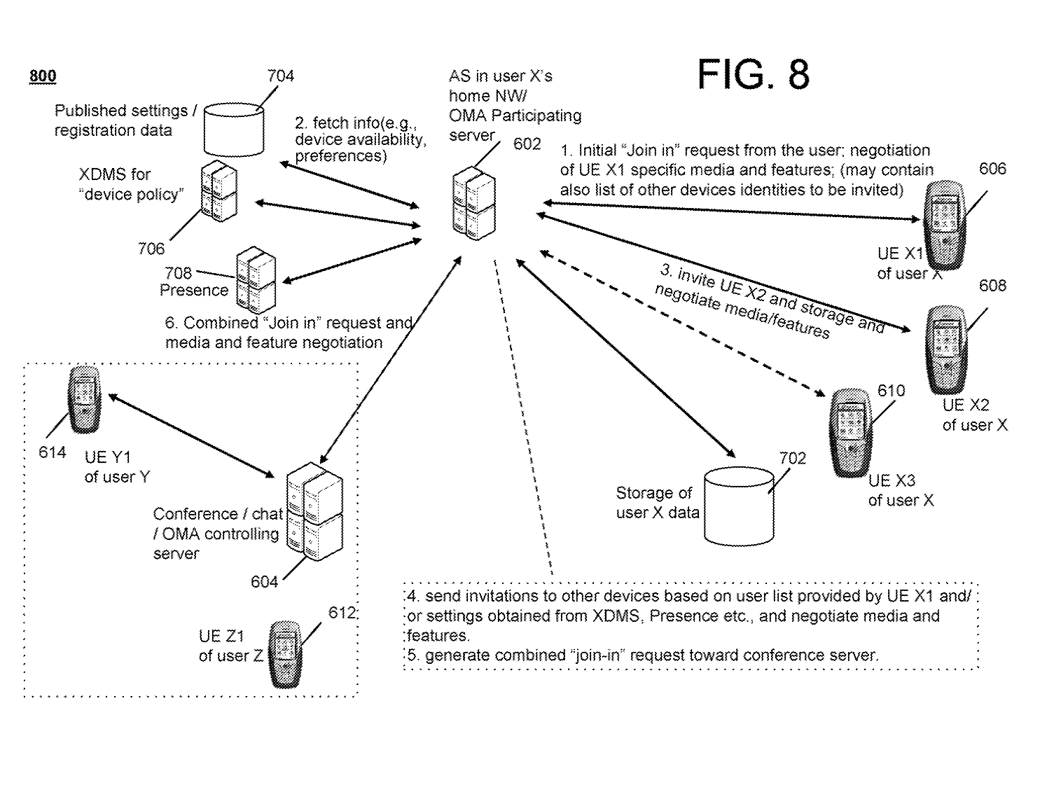

FIG. 8 is a diagram illustrating operation of a communication session according to an example embodiment. More particularly, FIG. 8 depicts an example scenario in which a user such as the example user X of FIG. 6 may join in a communication such as a group communication by sending a SIP INVITE to a conference server such as the server 604. According to an example embodiment, in scenarios wherein a user such as the user X joins a communication, the user may initiate media negotiation with at least one of the user's devices, for example, the UE device X1 606. An example AS on the originating side such as the server 602, which may receive the request from the device (e.g. the UE device X1 606) may be configured to automatically invite other devices to a session. According to an example embodiment, a user interface (UI) of the user's device may be configured so that the user may select the user's devices for the communication, and may inform the AS to add those devices to the communication. For example, the UE device X1 606 may send to the server 602 an initial “join in” request from the user. Negotiation of UE device X1 606 specific media and features may be performed between the server 602, the UE device X1 606, and the storage device 702. According to an example embodiment, the request may include a list of indicators of other devices be invited. For example, the list may include indicators associated with the devices 608, 702, 612, and 614.

The server 602 may then send invitations to other devices included in the list, and may collect information associated with the “participating” devices, and may then combine session information, and may initiate one session toward the example server 604, thus representing the user X as only one participant, instead of initiating a separate session for each of the devices 606, 608, 702. For example, the server 602 may obtain information such as device availability and preferences associated with each of the “participating” devices, from the example storage device 704, and may obtain information related to policy from the example server 706, and presence information from the example server 708.

According to an example embodiment, a user may join in a communication session with one of the devices and add others later. In this case the server 602 may then generate a session modification request (e.g., including the combined session information) and send the modification request to the server 604.

Thus, according to an example embodiment, the server 602 may negotiate the example combined media components and parameters, and example combined content types and features associated with the session with the controlling server such as the server 604, or other end-point of the communication. The communication session or conference may then be established between the user X and one or more of the users Y or Z. According to an example embodiment, the conference may already be ongoing when the user X joins; thus, the user X may be added to an existing conference.

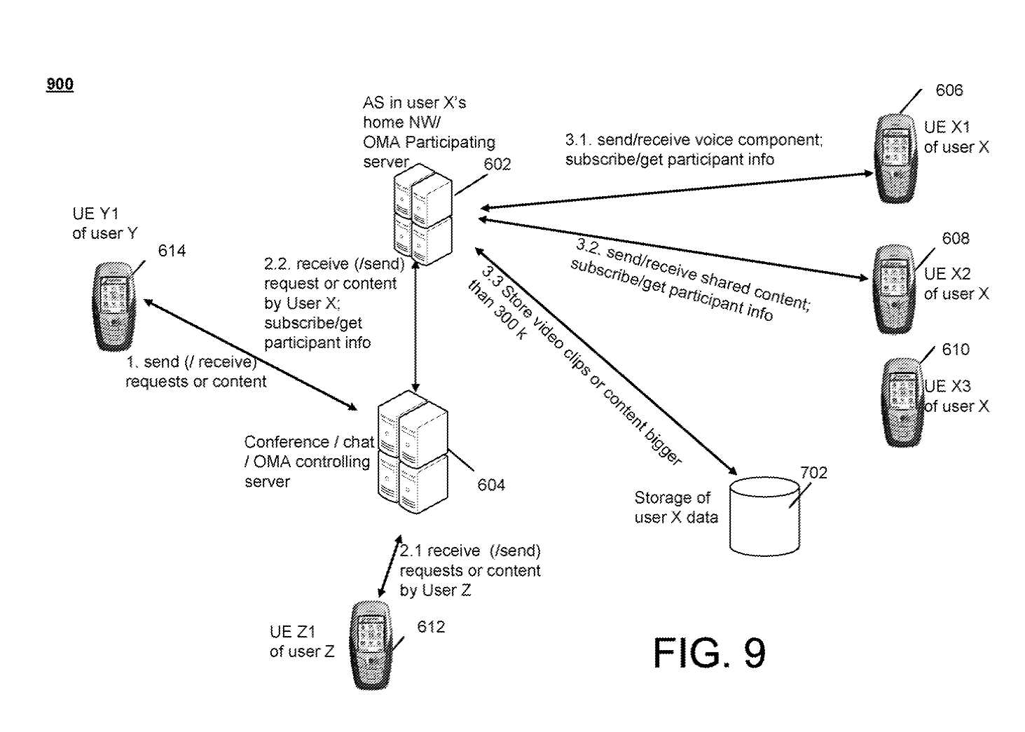

FIG. 9 is a diagram illustrating operation of a communication session according to an example embodiment. FIG. 9 depicts an example scenario 900 during an example communication according to an example embodiment. As shown in FIG. 9, the user Y associated with the UE device Y1 614 may wish to send/receive requests or content to other users such as the user X and the user Z. Therefore, the user Y may send a request for a communication to the server 604 indicating a request to send the desired requests or content. Similarly, the user Z associated with the UE device Z1 612 may send a request for a communication to the server 604 indicating a request to send desired requests or content associated with the user Z. Each of the users Y and Z may request communication with the user X, which appears as a single presence to the users Y and Z and to the server 604.

The server 604 may then send/receive requests or content in communication with the server 602. As discussed previously, the server 604 may send/receive information associated with the user X as a single presence, and the server 604 may not “see” the specific devices 606, 608, 610, 702 that may be associated with the user X.

On the example server 602 side, the user X may wish to send/receive a voice component of the communication between the server 602 and the UE device X1 606, and may wish to send/receive shared content between the server 602 and the UE device X2 608. Additionally, the user X may wish to store video clips or content larger than a predetermined size, such as 300 K, or alternatively “record” a portion of the communication, in the storage device 702. Thus, the server 602 may receive information or parameters associated with each of the devices 606, 608, 702 in order to negotiate parameters for a communication session or conference between the user X and other network entities such as users Y and/or Z.

As shown in FIG. 9, once example devices used for the communication session and example media used by the devices have been “negotiated” at the initiation of the communication, an AS such as the server 602 may handle request and media distribution accordingly, and may handle mapping of SIP header information accordingly for received and sent messages during the communication session. According to an example embodiment, if a set of media components are to be stored, the application server may distribute those components to an example storage system such as the example storage device 702. Such an example storage scheme may be determined at communication setup, and storage may be viewed as one of the devices, for example, one of the devices associated with the user X.

According to an example embodiment, when a user wants to add an additional device to a communication, delete or switch one or more devices during a communication, the application server such as the server 602 discussed previously may handle the device addition, deletion, or switch.

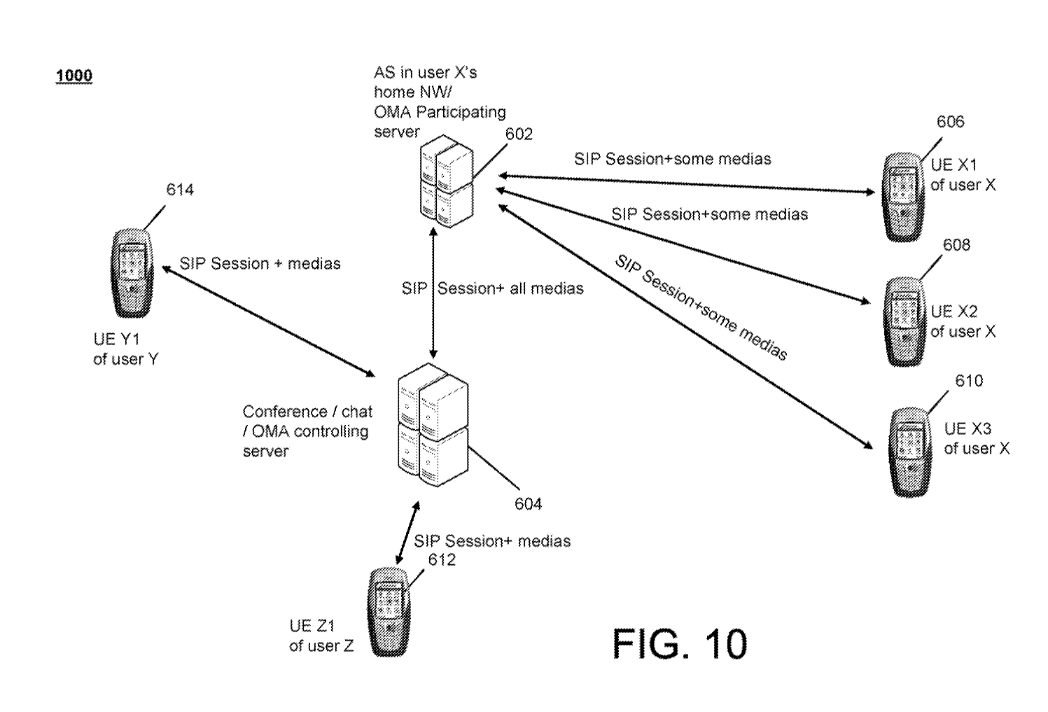

FIG. 10 is a diagram illustrating operation of an example communication session according to an example embodiment. The example session as shown in FIG. 10 is a simplified view of an example SIP communication session among the users X, Y, and Z, in which the SIP session and all media transmissions are transmitted between an AS server such as the server 602 and the conference server 604. However, the SIP session between the AS server 602 and the device equipment (e.g., devices 606, 608, 610) associated with user X may include split media transmissions for each of the devices associated with user X. For example, a video stream may be transmitted to a display device (e.g., device 606) associated with user X, while an accompanying audio stream may be transmitted simultaneously to an audio device (e.g., device 608) associated with user X, with the determination of the split handled by the AS server 602 based on negotiated parameters, which may be supplied by the user X. The devices associated with the users Y and Z may send/receive media transmissions that may include only a portion of the media transmissions that are sent between the AS server 602 and the conference server 604.

With regard to the user X in the example simplified view of FIG. 10, user Y and user Z may only see that the user X is participating to the session, for example, as a single network entity including a combination of capabilities associated with a group of one or more devices. Thus, the different devices of user X (e.g., UE X1 606, UE X2 608, UE X3 610) may not be visible to the user Y and User Z, as the server 602 may handle the communication between the users Y and Z, and the devices of the user X. Thus, the user X may join into a communication session using several devices (e.g., UE X1 606, UE X2 608, UE X3 610) simultaneously, and may switch between the devices so that other session participants (e.g., users Y, Z) are not aware of the switching of the devices by the user X.

According to an example embodiment, an AS server 602 as discussed previously with regard to FIGS. 6-10 may include an OMA IM and PoC participating server (or corresponding functionality similar to an OMA CPM Capability Center), or any other SIP AS in a user's home network dedicated for centralized the handling of multiple devices of a user. The AS may act as a Back-To-Back User Agent (B2BUA) to be able to create separate SIP sessions associated with different devices and a session associated with the other party of the communication, e.g., the (OMA IM or PoC) controlling server (if the controlling server is part of the communication) or another device. For example, the B2BUA may include a SIP based logical entity that may receive and process INVITE messages as a SIP User Agent Server (UAS). The B2BUA may also act as a SIP User Agent Client (UAC) that may determine how a request may be answered and may determine how to initiate outbound calls. Unlike an example SIP proxy server, the example B2BUA may maintain complete call state and may participate in all call requests.

According to an example embodiment, an AS may also use SIP mechanisms such as a mobile node control (MNC) for splitting SIP sessions, as well as example session description protocol (SDP) offers/answers, to devices and merging them towards entities outside a user's local environment.

According to an example embodiment, when a user subscribes information such as participant information associated with a group communication, the example AS may generate only one SIP SUBSCRIBE request to the controlling server, and may deliver notifications to those devices which have subscribed, or which are subscribing participant information.

According to an example embodiment, a GRUU or other more permanent device identity may be used, to handle multiple devices (e.g., routing of messages to a specific device) and to indicate a predetermined specific device, and to set and map a user's preferences to particular devices. According to an example embodiment, an example AS may base a decision of the selection of a potential set of devices on matching and comparing a GRUU or other more permanent device identity as discussed above with information received in an incoming request (including both an offer and requirements for supported features/media) or other dynamic, case-specific information such as time of day or date.

According to an example embodiment, an example AS may determine available devices and their capabilities and preferences of users via conventional SIP mechanisms (e.g., via a registration status), or by requesting information from OMA XDM servers or from an example presence server, as discussed previously with regard to FIGS. 7-8.

According to an example embodiment, when a user manually selects one of his/her devices for use in a communication, the device identifiers associated with the selected device may be included in the body of a SIP INVITE message, for example, as specified for a URI-list in accordance with OMA IM.

According to an example embodiment, entities other than the user (i.e., other network entities, e.g., conference servers, and other parties/participants) involved in the communication may advantageously not need to know about or handle several devices of the user. The other entities may only know an address associated with the user, and may be able to send only one request for the user, and not send requests directly to a specific device of the user.

According to an example embodiment, a user may automatically use devices that best fit the user's needs. For example, it may be more convenient to use a device having a big screen when following a visual presentation, but better voice quality for the verbal or audio portion of the presentation may achieved via a different device. According to an example embodiment, sensitivity requirements of the environment where the user is located may be considered in the selection of the devices to be used.

According to an example embodiment, a user may advantageously use multiple devices that may be available to the user and still receive all media if one device does not have capabilities to receive all the media types needed for a particular transmission.

According to an example embodiment, a user may check some portion of a communication (e.g., some stored media components) later if, for example, the portion is not supported by a device during a communication, or if the user wants to have a portion of a communication repeated.

According to an example embodiment, a user may be provided with a combined charging scheme and a centralized control for the charging for all devices used by the user, and the control of the charging may remain in a home network.

According to an example embodiment, a user of the example techniques discussed herein may advantageously receive a savings in signaling load savings. For example, the user may receive reduced rates for “combined” participant information subscriptions and/or notifications.

According to an example embodiment, if a user is moving or transitory when starting a communication, the user may later switch devices or, for example, move some media components of the communication to a device having better or enhanced capabilities when that device becomes relevant and/or available to the user. Example techniques described herein may relate to (one time) distribution of multimedia requests using such an environment.

Example techniques described herein may relate to multimedia communication, for example, using an example IP Multimedia Subsystem (IMS) where application servers and multiple devices per user are involved. For example, the user may attend a multimedia group communication (or conferencing) using different devices for different set of media components. Additionally, the user may switch devices during a session, delete a device, or add a new device and transfer one or more media components to that device in the session. According to an example embodiment, Session Initiation Protocol (SIP) may be used to establish and manipulate the communication (e.g., voice, video, messaging etc.). Example related standards associated with multimedia communications may include Open Mobile Alliance (OMA), for example, a Converged IP Messaging (CPM) enabler, PoC, or a SIP/SIMPLE IM enabler. Additionally, 3GPP conferencing and multimedia telephony may be used for such multimedia communications.

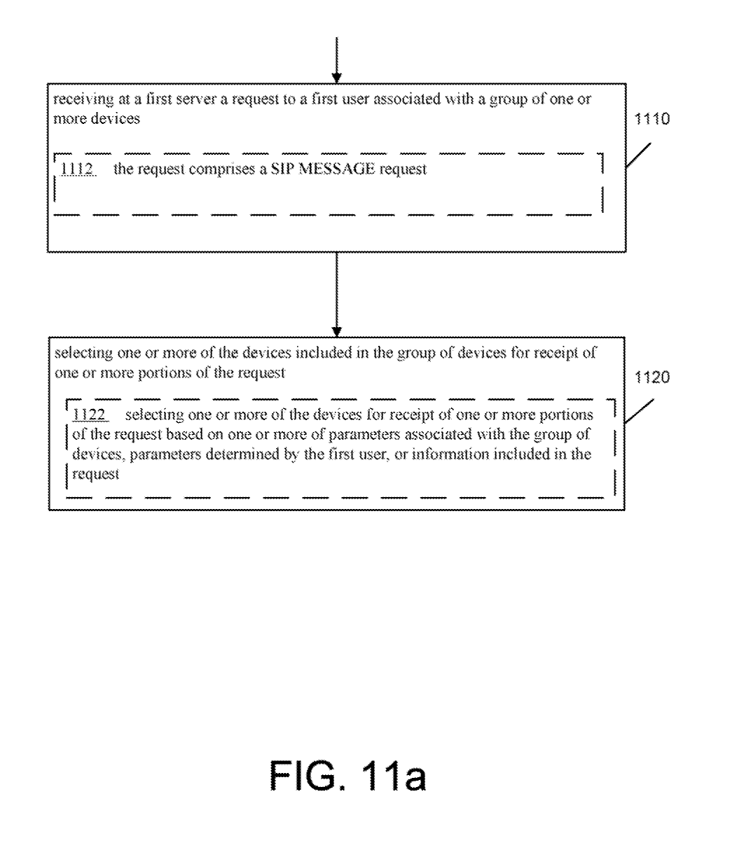

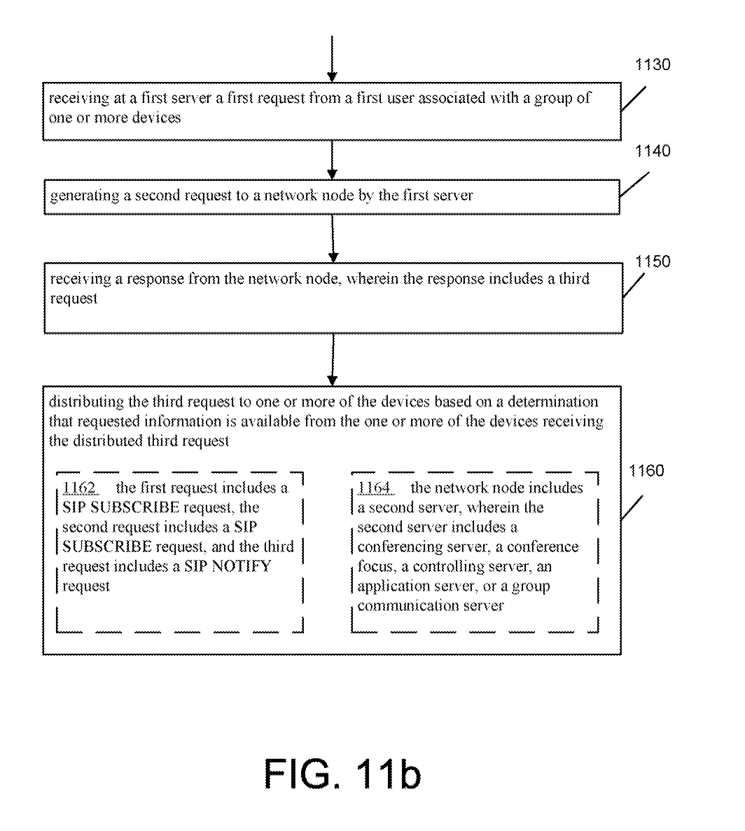

FIG. 11a is a flow chart illustrating operation of a node included a communication session according to an example embodiment. A request to a first user associated with a group of one or more devices may be received at a first server (1110). According to an example embodiment, the request may include a SIP MESSAGE request (1112).

One or more of the devices included in the group of devices may be selected for receipt of one or more portions of the request (1120). According to an example embodiment, the selecting may include selecting one or more of the devices for receipt of one or more portions of the request based on one or more of parameters associated with the group of devices, parameters determined by the first user, or information included in the request (1122).

FIG. 11b is a flow chart illustrating operation of a node included a communication session according to an example embodiment. A first request from a first user associated with a group of one or more devices may be received at a first server (1130).

A second request to a network node may be generated by the first server (1140).

A response may be received from the network node, wherein the response includes a third request (1150).

The third request may be distributed to one or more of the devices based on a determination that requested information is available from the one or more of the devices receiving the distributed third request (1160). According to an example embodiment, the first request may include a SIP SUBSCRIBE request, the second request may include a SIP SUBSCRIBE request, and the third request may include a SIP NOTIFY request (1162). According to an example embodiment, the network node may include a second server, wherein the second server may include a conferencing server, a conference focus, a controlling server, an application server, or a group communication server (1164).

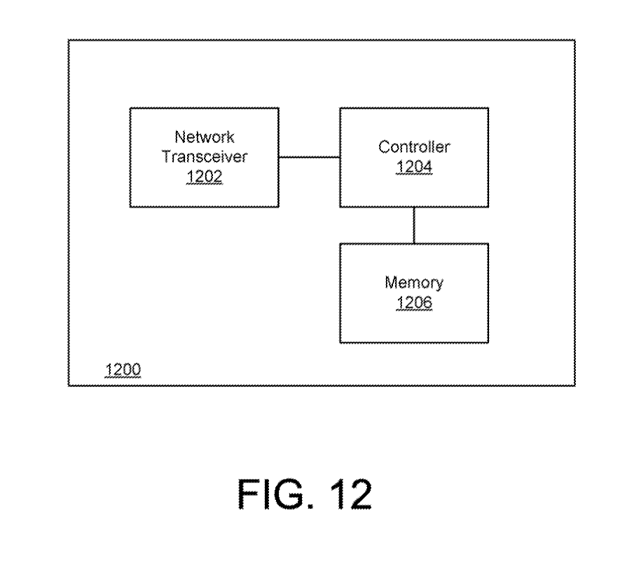

FIG. 12 is a block diagram illustrating an apparatus 1200 that may be provided in a network node according to an example embodiment. The network node may include, for example, a network transceiver 1202 to transmit and receive signals, a controller 1204 to control operation of the network node and execute instructions or software, and a memory 1206 to store data and/or instructions. Controller 1204 may be programmable, and capable of executing software or other instructions stored in memory or on other computer media to perform the various tasks and functions described above. In addition, a storage medium or computer readable medium may be provided that includes stored instructions, that, when executed by a controller or processor, may result in the controller (e.g., the controller 1204) performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or computer readable medium or in a propagated signal, for execution by, or to control the operation of, a data processing apparatus, e.g., a programmable processor or multiple processors, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
receiving at a first server a request for a communication session;
negotiating parameters associated with the communication session; and
selecting one or more devices included in a group of one or more devices associated with a first user for receipt of one or more portions of a requested transmission based on the negotiated parameters.

2. The method of claim 1 and further comprising;
generating the communication session, wherein the communication session comprises a communication session between the first user and a network node,
wherein the network node receives, from the first server, identifying information associated with the first user indicating the first user as a single network entity including a combination or capabilities associated with the group of one or more devices.

3. The method of claim 2 and further comprising:
receiving at the first server a notification or trigger to update the group of one or more devices associated with the first user.

4. The method of claim 3 wherein the update is associated with one or more of:
media in use, one or more media parameters, content types supported by media, or media features.

5. The method of claim 3 and further comprising:
modifying the combination of capabilities associated with the single network entity based on the notification or trigger to update the group of devices.

6-8. (canceled)

9. The method of claim 1 wherein:
receiving at a first server a request for a communication session comprises receiving at the first server a request for a communication session between the first user and a network node.

10. The method of claim 9 wherein:
receiving at a first server for a communication session comprises receiving at the first server a request for a communication session between the first user and a second server.

11. The method of claim 10 wherein:
the second server includes one or more of a conference server, a group communication server, a controlling server, or an application server.

12. The method of claim 9 wherein:
receiving at a first server a request for communication session comprises receiving at the first server a request for a communication session between the first user and a second user.

13-15. (canceled)

16. The method of claim 1 wherein:
receiving at a first server request for a communication session comprises receiving at an application server (AS) an invitation associated with the communications session between the first user and a network node, and
negotiating parameters associated with the communication session comprises negotiating, between the AS and one or more of the devices included in the group of devices, parameters associated with the communication session, and
wherein the method further comprises:
sending the invitation to the one or more of the devices included in the negotiating the parameters.

17. (canceled)

18. The method of claim 1 wherein:
receiving at a first server a request for a communication session comprises receiving from the first user at an application server (AS) an invitation associated with the communication session, and
wherein the method further comprises:
sending the invitation to a network node.

19-21. (canceled)

22. The method of claim 1, and further comprising:
receiving at the first server a transmission associated with a group of media components and in indicator associated with the first user, and
sending the group of media components from the first server to the one or more devices included in the group of devices selected for receipt of one or more portions of the transmission based on the negotiated parameters, based of the selecting.

23. The method of claim 22 wherein the transmission comprises a Message Session Relay Protocol (MSRP) transmission or a Real-time Transport Protocol (RTP) transmission.

24. The method of claim 2 wherein:
selecting the one or more of the devices comprises selecting, at the first server, one or more of the devices included in the group of devices for receipt of one or more portions of the requested transmission based on negotiated parameters.

25. The method of claim 1 wherein:
selecting the one or more of the devices comprises selecting one or more of the devices included in the group of devices for receipt of one or more portions of the requested transmission based on the negotiated parameters, based on a selection by the first user of the one or more of the devices.

26. The method of claim 1 wherein:
selecting the one or more of the devices comprises selecting one or more of the devices included in the group of devices for receipt of one or more portions of the requested transmission based on parameters associated with the group of devices, based on a selection by the first user of the one or more of the devices.

27. The method of claim 1 and further comprising:
sending the request for the communication session to each of the devices included in the group of devices,
receiving from the first user an acceptance of at least a portion of the communication session, wherein the acceptance indicates one or more of the devices included in the group for the receipt of the one or more portions of the requested transmission; and
negotiating session parameters associated with the communication session based on the parameters associated with the group of devices.

28. The method of claim 1 and further comprising:
determining at the first server parameters associated with the group of devices based on device registration information;
determining one or more devices included in the group of devices for receipt of the request for the communication session based on the determined parameters associated with the group of devices;
sending the request for the communication session to each of the determined devices included in the group of devices; and
negotiating session parameters associated with the communication session based on parameters associated with the determined devices included in the group of devices.

29. The method of claim 1 and further comprising:
determining at the first server parameters associated with the group of devices based on device information provided by the first user and stored at a second server;
determining one or more devices included in the group of devices for receipt of the request for the communication session based on the determined parameters associated with the group of devices;
sending the request for the communication session to each of the determined devices included in the group of devices; and
negotiating session parameters associated with the communication session based on parameters associated with the determined devices included in the group of devices.

30-33. (canceled)

34. A method comprising:
sending, from a network node, a request for a communication session with a first user; and
negotiating parameters associated with the communication session,
wherein the first user is associated with a group of one or more devices, and
wherein a first server selects one or more of the devices included in the group of devices for receipt of one or more portions of a requested transmission.

35. The method of claim 34 and further comprising:
generating the communication session, wherein the communication session comprises a communication session between the first user and the network node; and
receiving, from the first server, identifying information associated with the first user indicating the first user as a single network entity including a combination of capabilities associated with the group of one or more devices.

36-37. (canceled)

38. The method of claim 34 wherein:
the first server and the network node are included in a Third Generation Partnership Project, 3GPP/3GPP2 network.

39-40. (canceled)

41. A method comprising:
receiving, by a device associated with a first user, from a first server, a first portion of a transmission based on negotiated parameters,
wherein the first user is associated with a group of one or more devices including the device,
wherein the transmission comprises a transmission to the first user that is requested by a network node,
wherein the first server selects one or more of the devices included in the group of devices for receipt of one or more portions of the requested transmission based on the negotiated parameters, wherein the one or more portions includes the first portions,
wherein the receiving the first portion comprises receiving, by the device associated with the first user, from the first server, the first portion of the transmission based of the negotiated parameters and the selecting.

42. (canceled)

43. The method of claim 41 wherein:
the first server comprises a media server, an application server (AS), or a media controller/switch controlled by AS.

44. The method of claim 41 wherein:
the network node comprises a media server, a conference server, or a media controller/switch controlled by a conference server.

45-46. (canceled)

47. An apparatus for communications the apparatus comprising:
a controller;
a memory coupled to the controller; and
a network transceiver coupled to the controller;
the apparatus adapted to:
receive a request for a communication session with a first user associated with a group of one or more devices;
negotiate parameters associated with the communication session; and
select one or more of the devices included in the group of devices for receipt of one or more portions of a requested transmission based on the negotiated parameters.

48. The apparatus of claim 47 wherein:
the apparatus comprises an application server (AS).

49. (canceled)

50. The apparatus of claim 47 wherein:
the apparatus is adapted to generate the communication session, wherein the communication session comprises a communication session between the first user and a network node,
wherein the network node receives, from the apparatus, identifying information associated with the first user indicating the first user as a single network entity including a combination of capabilities associated with the group of one or more devices.

51. (canceled)

52. A computer program product being tangibly embodied on a computer-readable medium and being configured to cause a data processing apparatus to:
receive a request for a communication session;
negotiate parameters associated with the communication session;
receive information indicating a requested transmission to a first user associated with a group of one or more devices; and
select one or more of the devices included in the group of devices for receipt of one or more portions of the requested transmission based on the negotiated parameters.

53-61. (canceled)

62. A method comprising:
receiving at a first server a request to a first user associated with a group of one or more devices; and
selecting one or more of the devices included in the group of devices for receipt of one or more portions of the request.

63. The method of claim 62 wherein the request comprises a SIP MESSAGE request.

64. The method of claim 62 wherein selecting one or more of the devices comprises selecting one or more of the devices for receipt of one or more portions of the request based on one or more of:
parameters associated with the group of devices, parameters determined by the first user, or information included in the request.

65. A method comprising:
receiving at a first server a first request from a first user associated with a group of one or more devices;
generating a second request to a network node by the first server;
receiving a response from the network node, wherein the response third request; and
distributing the third request to one or more of the devices based in a determination that requested information is available from the one or more of the devices receiving the distributed third request.

66. The method of claim 65 wherein the first request comprises a SIP SUBSCRIBE request, the second request comprises a SIP SUBSCRIBE request, and the third request comprises a SIP NOTIFY request.

67. The method of claim 65 wherein:
the network node comprises a second server, wherein the second server includes a conferencing server, a conference focus, a controlling server, and application server, or a group communcation serve.
